(19) United States
(12) Patent Application Publication
(10) Pub. No.: US 2005/0147095 A1
(43) Pub. Date: Jul. 7, 2005

(54) IP multicast packet burst absorption and multithreaded replication architecture

(75) Inventors: Miguel A. Guerrero, Fremont, CA (US); Rahul Saxena, Sunnyvale, CA (US); Chien-Hsin Lee, Folsom, CA (US); Muralidharan S. Chilukoor, Bangalore (IN)

Correspondence Address: Jung-Hua Kuo Attorney at Law;c/o PortfolioIP, P.O. Box 52050, Minneapolis, MN, 55402, US

(73) Assignee: Intel Corporation, Santa Clara, CA (US)

(21) Appl. No.: 10/749,034

(22) Filed: Dec. 30, 2003

(51) Int. Cl. H04L 12/56

(52) U.S. Cl. 370/390

(57) ABSTRACT

Systems and methods for IP multicast packet burst absorption and multithreaded replication architecture are disclosed. Replications of IP multicast packets are performed in a control plane of a network device. The network device may include a data plane for transmitting data between ingress and egress ports and a control plane including a shared transmit/receive queue infrastructure configured to queue incoming multicast packets to be replicated on a per ingress port basis and to queue transmit packets, and a multicast processing engine in communication with the shared queue infrastructure and including a circular replication buffer to facilitate multithreaded replication of multicast packets on a per egress virtual local area network (VLAN) replication basis. The shared transmit/receive queue infrastructure may dynamically allocate memory between the transmit and receive multicast queues.

### BACKGROUND OF THE INVENTION

A network generally refers to computers and/or other device interconnected for data communication. A host computer system can be connected to a network such as a local area network (LAN) via a hardware device such as a network interface controller or card (NIC). The basic functionality of the NIC is to send and/or receive data between the host computer system and other components of the network. To the host computer, the NIC appears as an input/output (I/O) device that communicates with the host bus and is controlled by the host central processing unit (CPU) in a manner similar to the way the host CPU controls an I/O device. To the network, the NIC appears as an attached computer that can send and/or receive packets. Generally, the NIC does not directly interact with other network components and do not participate in managing of network resources and services.

A virtual LAN (VLAN) is a switched network using Data Link Layer (Layer 2 or L2) technology with similar attributes as physical LANs. VLAN is a network that is logically segmented, e.g., by department, function or application, for example. VLANs can be used to group end stations or components together even when the end stations are not physically located on the same LAN segment. VLANs thus eliminate the need to reconfigure switches when the end stations are moved.

Internet Protocol (IP) multicasting is a networking technology that delivers information in the form of IP multicast (Mcast) packets to multiple destination nodes while minimizing traffic carried across the intermediate networks. Rather than delivering a different copy of each packet from a source to each end station, IP multicast packets can be delivered to special IP multicast addresses that represent the group of destination stations and intermediate nodes are responsible for creating extra copies of the IP multicast packets on outgoing ports as needed.

For L2 (such as Ethernet) multicast packets, at most one copy of the packet is delivered to each outgoing port per input packet. In contrast, multiple copies of a single IP multicast packet may need to be delivered on a given outgoing port. For example, a different copy of the multicast packet is sent on each VLAN where at least one member of the multicast group is present on that port. The replication is referred to as IP multicast 10 replication on an egress port and may cause a given input packet to be processed and sent out on a given port multiple times. As an example, where 10 customers sign up for a video broadcast and each customer is on a different VLAN all co-existing and reachable through a given output port, the corresponding input multicast packet is replicated such that 10 distinct copies of the multicast packets are sent on the given output port.

As is evident, in IP multicasting, bandwidth requirements at the output port may be higher than at the input port because of the IP multicast replication. Buffering is thus important to avoid packet drop during bandwidth peaks. Furthermore, IP multicasting may also cause head of line blocking. A network element such as a switch or router may store packets in a first-in first-out (FIFO) buffer where each input link has a separate FIFO. Head of line blocking occurs when packets behind the first packet are blocked if the first packet needs a resource that is busy. For example, when the first packet at the front (head of line) of the FIFO is to go out on a currently busy link B and the second packet is to go out on a currently idle link C, the first (head of line) packet blocks (because its egress link B is busy) the second packet despite that egress link C is idle because only the first packet can be accessed in the FIFO.

### BRIEF DESCRIPTION OF THE DRAWINGS

The present invention will be readily understood by the following detailed description in conjunction with the accompanying drawings, wherein like reference numerals designate like structural elements.

FIG. 1 is a block diagram illustrating various components of a control plane implemented in a network element or device for IP multicast packet burst absorption and/or multithreaded IP multicast replication.

FIG. 2 is a flowchart of an illustrative process for IP multicast packet burst absorption and/or multithreaded IP multicast replication by a control plane implemented in a network element.

FIG. 3 is a diagram of an illustrative system in which the control plane of FIG. 1 may be employed.

### DESCRIPTION OF SPECIFIC EMBODIMENTS

Systems and methods for IP multicast packet burst absorption and multithreaded replication architecture are disclosed. It should be appreciated that the present invention can be implemented in numerous ways, including as a process, an apparatus, a system, a device, a method, or a computer readable medium such as a computer readable storage medium or a computer network wherein program instructions are sent over optical or electronic communication lines. Several inventive embodiments of the present invention are described below. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

Replications of IP multicast packets are performed in a control plane of a network device. The network device may include a data plane for transmitting data between ingress and egress ports and a control plane including a shared transmit/receive queue infrastructure configured to queue incoming multicast packets to be replicated on a per ingress port basis and to queue transmit packets, and a multicast processing engine in communication with the shared queue infrastructure and including a circular replication buffer to facilitate multithreaded replication of multicast packets on a per egress virtual local area network (VLAN) replication basis. The shared transmit/receive queue infrastructure may dynamically allocate memory between the transmit and receive multicast queues.

The multicast processing engine may be configured to request multicast packets from the transmit/receive queue infrastructure upon emptying a slot in the circular replication buffer, the requested multicast packet being from an ingress port determined based on a bandwidth management policy. A slot in the circular replication buffer is emptied when all replications for the multicast packet occupying the slot are performed. The multicast processing engine may include a scheduler that utilizes scheduling algorithms to dynamically adapt the rate at which multicast packets are de-queued for each ingress port as a function of how much output bandwidth each ingress port utilizes. The scheduler is preferably configured to request multicast packets from the shared transmit/receive queue infrastructure with a policy to maintain a plurality of threads of replication in the circular replication buffer.

The control plane may also include a packet parser configured to input queue a multicast packet header in the shared transmit/receive queue infrastructure on a per ingress port basis. The packet parser may de-queue a multicast packet from the shared transmit/receive queue infrastructure corresponding to an ingress port as determined by the multicast processing engine. The multicast processing engine can forward a replicated multicast packet onto a main control plane pipeline when traffic on the main control plane pipeline allows.

In another embodiment, a control plane multicast packet processing engine may include a circular replication buffer for facilitating multithreaded replication of multicast packets on a per egress VLAN replication basis and a scheduler in communication with a shared transmit/receive queue infrastructure for queuing incoming multicast packets to be replicated on a per ingress port basis and for queuing transmit packets. The scheduler may be configured to de-queue multicast packets associated with the ingress ports into the circular replication buffer and to utilize scheduling algorithms to dynamically adapt the rate at which the multicast packets are de-queued from each ingress port as a function of how much output bandwidth each ingress port utilizes.

In yet another embodiment, a computer program package embodied on a computer readable medium, the computer program package including instructions that, when executed by a processor, cause the processor to perform actions including queuing incoming multicast packets to be replicated on a per ingress port basis in a shared transmit/receive queue infrastructure configured to queue the incoming multicast packets to be replicated and transmit packets, determining an ingress port from which to de-queue multicast packets, de-queuing multicast packets from the shared transmit/receive queue infrastructure, the de-queued multicast packets being associated with the determined ingress port and placed into a replication buffer for replication, and performing multithreaded replication of multicast packets on a per egress virtual local area network (VLAN) replication basis utilizing a replication buffer.

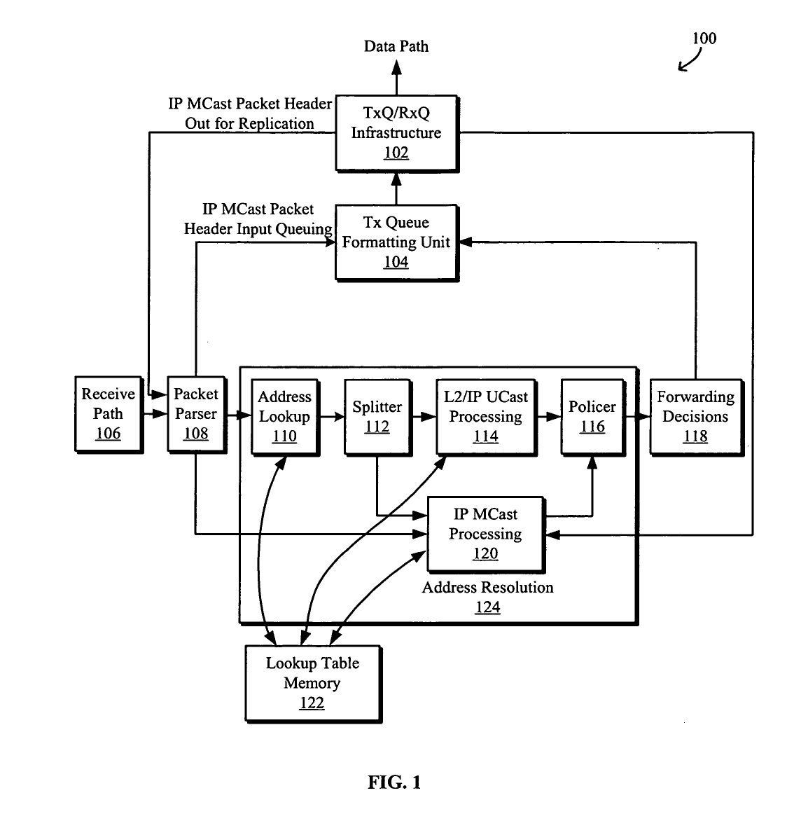

FIG. 1 is a block diagram illustrating various components of a control plane 100 implemented in a network element or device for IP multicast packet burst absorption and/or multithreaded IP multicast replication. In particular, FIG. 1 illustrates various components of the control plane 100 relating to the processing and replication of incoming IP multicast packets while various other components relating to conventional processing of incoming IP unicast packets are not shown for purposes of clarity. The network element or device may be, for example, a router, a switch, or the like. The control plane 100 interfaces with a data plane that is preferably logically separate from the control plane 100. In general, the network device includes both the data plane and the control plane. The data plane relays datagrams or data packets between a pair of receive and transmit network interface ports. The control plane, in communication with the data plane, runs management and control operations, such as routing and policing algorithms which provide the data plane with instructions on how to relay cell/packets/frames. The separation between the data plane and the control plane in the network device may merely be a logical separation or may optionally be a physical separation.

As shown in FIG. 1, incoming packets are received by the control plane 100 of the network device via a receive path block 106 representing a data path receive side of the control plane. The receive path block 106 feeds a header of each incoming packet to a packet parser 108 for packet classification and for extraction of forwarding information for the packet by the control plane 100.

The packet parser 108, the initial stage for the control plane 100, extracts and normalizes information about the packet. If the packet parser 108 determines that the incoming packet is an IP multicast packet, the packet parser 108 may input queue the IP multicast packet using a data path shared memory infrastructure 102 on a per ingress port basis via a queuing manager 104. The data path shared memory infrastructure 102 is a combined receive and transmit queuing. The packet parser 108 forwards IP multicast packet header to the queuing manager 104 for input queuing in the combined receive and transmit queuing infrastructure 102. The receive and transmit queuing infrastructure 102 is also referred to herein as a receive queue when referenced with respect to incoming packets and as a transmit queue when referenced with respect to outgoing packets. Input IP multicast packets are queued in the data path shared memory infrastructure 102 until forwarding information is available from the control plane 100, as will be described in more detail below. Queuing of input IP multicast packets on a per ingress port basis allows sharing of the receive queue memory with the transmit queue memory 102 to provide IP multicast buffering capabilities.

Whenever IP multicast packets in the receive queue 102 are available, the packet parser 108 may decide whether to feed packets incoming from the regular datapath flow, e.g., IP unicast packets, L2 packets and/or multi-protocol label switching (MPLS) packets, or from the IP multicast packets available on the receive queue 102 according to a bandwidth management policy, e.g., strict lower priority for receive queue packets. Once the packet parser 108 decides to pull a multicast packet from the receive queue 102, an IP multicast processing engine 120, rather than the packet parser 108, may determine from which input port to request transmit packets from the receive queue 102. The IP multicast processing engine 120 receives status from the packet parser 108 to indicate which input queues have IP multicast packets. IP multicast packets read from the receive queue 102 may be flagged as IP multicast packets already input queued and enter the main control plane pipeline, i.e., the pipeline taken by other, e.g., L2, IP and/or MPLS packets, after full parsing.

The IP multicast packets flow through the main control plane pipeline similar to other packets until the IP multicast packet reaches an address resolution engine 124. As shown, the address resolution engine 124 may include an address lookup engine 110 in which the packet source/destination addresses are queried, e.g., via a lookup table memory 122, to retrieve the forwarding information associated with the IP multicast packets. The address lookup engine 110 may perform address look-ups on various types of addresses, such as IP and/or MAC addresses, for example.

After address resolution is performed, a splitter 112 of the address resolution engine 124 separates IP multicast packets from the other (non IP multicast) packets and forwards the IP multicast packets to the IP multicast processing engine 120 such that the IP multicast packets are branched off of the main control plane pipeline. The other (non IP multicast) packets continue along the main control plane pipeline to the L2/IP unicast processing block 114 and to a policer 116.

The IP multicast processing engine 120 may include a circular replication buffer structure that allows multithreaded replication of the IP multicast packets. Each slot in the circular replication buffer is emptied when all replications for the corresponding IP multicast packet previously occupying the slot are performed. As slots in the circular replication buffer are emptied, a scheduler of the IP multicast processing engine 120 requests another IP multicast packet from the receive queue 102 via the packet parser 108. The input port from which an IP multicast packet is requested by the IP multicast processing engine 120 may be determined by the scheduler based on a bandwidth management policy.

The IP multicast processing engine 120 preferably utilizes scheduling algorithms to dynamically adapt the rate at which packets are de-queued from the inputs port as a function of how much output bandwidth each input port is using. Thus, the request to the receive queue 102 from the scheduler of the IP multicast processing engine 120 is preferably made with sufficient lead time to compensate for the delay of the pipeline such that the circular replication buffer does not suffer underflow conditions. In particular, the scheduler requests new IP multicast packets from the receive queue 102 according to a policy to keep several threads of replication in the circular replication buffer. In other words, the scheduler preferably tries to keep the circular replication buffer busy.

The replicated IP multicast packets from the IP multicast processing engine 120 are fed back to the main control plane pipeline at a policer 116 when traffic on the main control plane pipeline allows, e.g., due to the lower priority of the IP multicast packets. In other words, empty slots can be filled with replicated multicast packets from the IP multicast processing engine 120 at the policer 116. The replicated multicast packets that the policer 116 receives from the IP multicast processing engine 120 can specific the associated output port. Generally, the fact that the IP multicast packets branch to the IP multicast processing engine 120 implies slots will be available on the main control plane pipeline for packets from the IP multicast processing engine 120 to return to the main control plane pipeline at the policer 116.

The policer 116 forwards the replicated IP multicast packets and non-multicast packets to a forwarding decisions engine 118. The forwarding decisions engine 118 generally behaves transparently or almost transparently to whether the packet is IP unicast or multicast. The forwarding decisions engine 118 may apply forwarding rules of the packet and makes forwarding decisions based on the address lookups previously performed. For example, the forwarding decisions engine 118 may apply egress-based access control lists (ACLs) to allow filtering, mirroring, QoS, etc. Thus, performing IP multicast replication on the control plane 100 rather than on the data plane allows consistent and transparent treatment of features such as supporting egress-based access control lists (e.g., filtering on a per egress port/VLAN basis) software-friendly data structures, egress VLAN-based statistics for IP multicast packets, etc. The forwarding decisions engine 118 may apply rules based on a key extracted from the packet. This key includes egress information, e.g., egress VLAN or port, such that the forwarding decisions engine 118 may obtain different values, i.e., different egress information, for different replications of the IP multicast packet.

The queuing manager 104, the last stage of the control plane 100, receives forwarding information from the forwarding decisions engine 118. When forwarding information becomes available, the corresponding IP multicast packet is queued in the receive queue 102. Per port de-queuing processes match the forwarding information received by the queuing manager 104 with the packet stored in data path shared memory 102. In particular, the queuing manager 104 may gather and place forwarding information in an optimal compact format to be sent onto physical output port queues. When forwarding information becomes available via the queuing manager 104, the forwarding information along with the corresponding IP multicast packet are queued in the transmit queues 102 based on, for example, the order of the traffic pattern between IP multicast and non-IP multicast packets. Such ordering may help to reduce the peak bandwidth requirement to the shared memory 102 under burst IP multicast traffic and also maintains the order of the traffic pattern. Per ingress port de-queuing processes match the forwarding information with the IP multicast packet stored in the data path shared transmit/receive memory infrastructure 102 for final editing and transmission to the physical ports of the network device.

The receive queue 102 holds incoming IP multicast packet header information until requested by an IP multicast processing engine 120. Specifically, when IP multicast packets are available, the packet parser 108 pulls IP multicast packet header corresponding to the input port as specified by the IP multicast processing engine 120 from the receive queue 102 according to the request from the IP multicast processing engine 120.

The replication of the IP multicast packets is implemented in the control plane rather than the data plane of the network device. Such replication in the control plane allows a natural extension of various supported IP unicast features (e.g., access control lists (ACLs), storm control, etc.) with little or no additional complexity in the control plane. In particular, special multicast treatment is provided for a few of the functional blocks in the control plane.

In the control plane 100 as described herein, IP multicast packet processing or replication is performed in such a way that is transparent or nearly transparent to many of the functional blocks of the control plane 100 implemented in the network device. Such transparency allows those functional blocks and the corresponding existing IP unicast handling hardware to be reused for IP multicast processing. In other words, the above-described control plane 100 utilizes much of the IP unicast infrastructure for IP multicast processing (replication) to facilitate in providing simplicity, low gate count and/or low schedule impact to support IP multicast processing. In particular, the IP multicast processing engine 120 performs per egress VLAN replication such that replicated packets are treated similar to the IP unicast flow as much as possible.

For example, the transmit queue infrastructure 102 is reused as a receive queue for input queuing of IP multicast packets. As described above, IP multicast packets are input queued by reusing (sharing) the hardware structures designed for output (transmit) queuing. The shared memory provides good buffering capabilities by leveraging from the sharing of memory between the receive and transmit sides, the memory being flexibly and dynamically allocated between input and output queues as needed. Such shared memory input queuing of IP multicast packets allows supporting a long burst of traffic where the bandwidth demands are above the bandwidth capabilities of the output ports while avoiding dropping of packets. In addition, exact match address resolution engines available for L2 packets address queries are also re-used for IP multicast address querying.

The control plane replication of IP multicast packets also facilitates in minimizing head of line blocking on the input queue by scheduling from which input port to request IP multicast packets based on, for example, internal measurements of recent forwarding activity and/or by providing multithreaded replication of several flows in parallel while maintaining packet ordering per flow/VLAN. The IP multicast processing hardware engine facilitates multithreaded replication of different flows, i.e., interleaves the replication of IP multicast packets from different input port flows such that none of them blocks the rest.

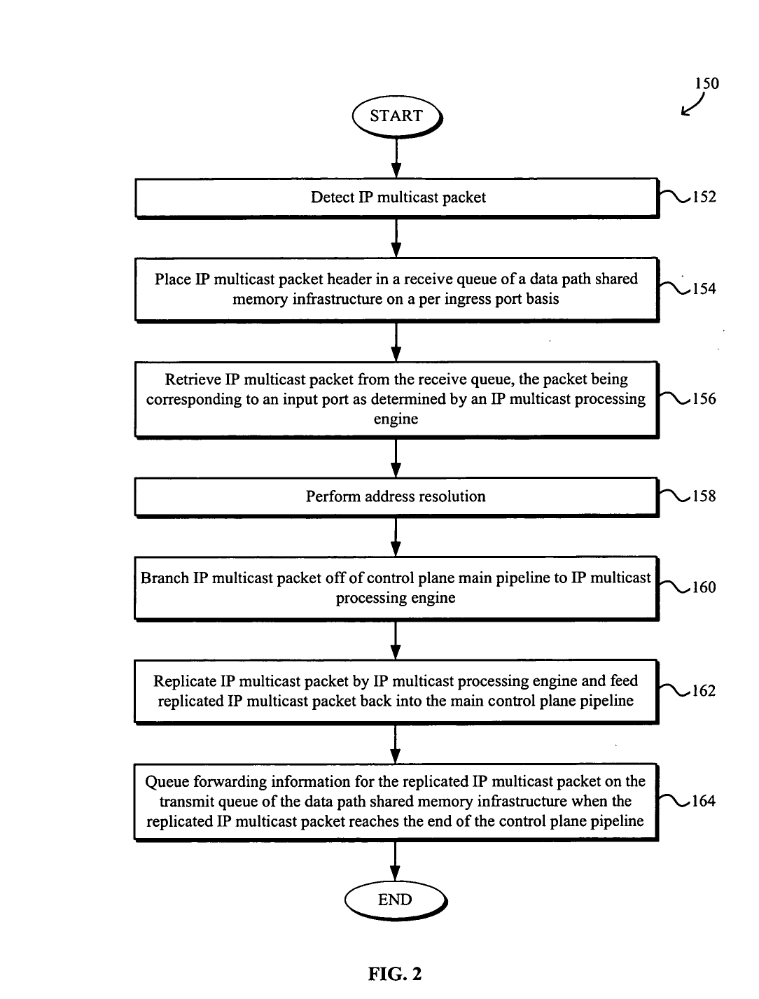

FIG. 2 is a flowchart of an illustrative process 150 for IP multicast packet burst absorption and/or multithreaded IP multicast replication by a control plane implemented in a network element. A packet parser detects an IP multicast packet at block 152 and the IP multicast packet header is input queued in a receive queue of a data path shared memory infrastructure at block 154. The receive queue is a data path shared memory infrastructure. The IP multicast packet is queued on a per ingress port basis via a queuing manager. The data path shared memory infrastructure is preferably a combined receive and transmit queuing.

At block 156, the packet parser determines to feed a IP multicast packet available on the receive queue according to a bandwidth management policy, e.g., strict lower priority for receive queue IP multicast packets. The input port corresponding to the IP multicast packet retrieved by the packet parser may be determined by an IP multicast processing engine. The IP multicast packet may be flagged as an IP multicast packet already input queued. In particular, a scheduler of the IP multicast processing engine requests IP multicast packets from the receive queue via the packet parser so as to avoid an underflow condition at a circular replication buffer of the IP multicast processing engine.

After address resolution at block 158, the IP multicast packet branches off of the control plane main pipeline to the IP multicast processing engine at block 160. The IP multicast processing engine replicates the IP multicast packets and feeds the replicated IP multicast packet back into the main control plane pipeline at a policer of the control plane at block 162. At block 164, the replicated IP multicast packet reaches the end of the control plane pipeline, forwarding information for the replicated IP multicast packet is queued on the transmit queue of the data path shared memory infrastructure.

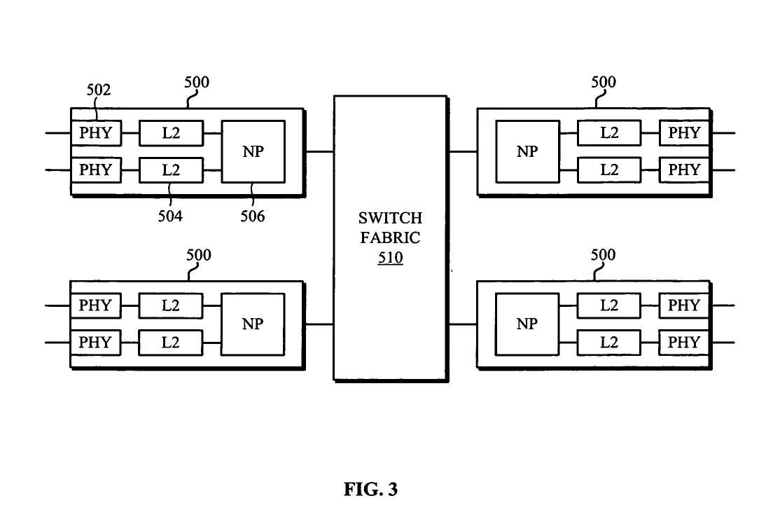

The systems and methods described above can be used in a variety of systems. For example, without limitation, the control plane shown in FIG. 1 can be implemented as part of a larger system (e.g., a network device). For example, FIG. 3 is a block diagram of an illustrative system in which the control plane of FIG. 1 may be employed. As shown in FIG. 3, the system features a collection of line cards or “blades” 500 interconnected by a switch fabric 510 (e.g., a crossbar or shared memory switch fabric). The switch fabric 510 may, for example, conform to the Common Switch Interface (CSIX) or another fabric technology, such as HyperTransport, Infiniband, PCI-X, Packet-Over-SONET, RapidIO, or Utopia.

Individual line cards 500 may include one or more physical layer devices 502 (e.g., optical, wire, and/or wireless) that handle communication over network connections. The physical layer devices 502 translate the physical signals carried by different network media into the bits (e.g., 1s and 0s) used by digital systems. The line cards 500 may also include framer devices 504 (e.g., Ethernet, Synchronous Optic Network (SONET), and/or High-Level Data Link (HDLC) framers, and/or other “layer 2” devices) that can perform operations on frames such as error detection and/or correction. The line cards 500 may also include one or more network processors 506 to, e.g., perform packet processing operations on packets received via the physical layer devices 502.

While the preferred embodiments of the present invention are described and illustrated herein, it will be appreciated that they are merely illustrative and that modifications can be made to these embodiments without departing from the spirit and scope of the invention. Thus, the invention is intended to be defined only in terms of the following claims.

1. A network device, comprising:
a data plane for transmitting data between an ingress port and an egress port; and
a control plane in communication with the data plane, the control plane including:
a shared transmit/receive queue infrastructure configured to queue incoming multicast packets to be replicated on a per ingress port basis and to queue transmit packets, and
a multicast processing engine in communication with the shared transmit/receive queue infrastructure, the multicast processing engine including a circular replication buffer to facilitate multithreaded replication of multicast packets on a per egress virtual local area network (VLAN) replication basis.

2. The network device of claim 1, in which the multicast processing engine is configured to request multicast packets from the shared transmit/receive queue infrastructure upon emptying a slot in the circular replication buffer, the requested multicast packet being from an ingress port determined based on a bandwidth management policy implemented by the multicast processing engine, and in which the multicast processing engine empties a slot in the circular replication buffer when all replications for the multicast packet occupying the slot are performed.

3. The network device of claim 1, in which the shared transmit/receive queue infrastructure dynamically allocates memory to the transmit packets and to the incoming multicast packets to be replicated.

4. The network device of claim 1, in which the multicast processing engine includes a scheduler utilizing scheduling algorithms to dynamically adapt the rate at which multicast packets are de-queued for each ingress port as a function of how much output bandwidth each ingress port utilizes.

5. The network device of claim 1, in which the scheduler is configured to request multicast packets from the shared transmit/receive queue infrastructure with a policy to maintain a plurality of threads of replication in the circular replication buffer.

6. The network device of claim 1, in which the control plane further includes a packet parser configured to input queue a multicast packet header in the shared transmit/receive queue infrastructure on a per ingress port basis.

7. The network device of claim 6, in which the packet parser is further configured to de-queue a multicast packet from the shared transmit/receive queue infrastructure, the de-queued multicast packet corresponding to an ingress port as determined by the multicast processing engine.

8. The network device of claim 1, in which the multicast processing engine forwards a replicated multicast packet onto a main control plane pipeline when traffic on the main control plane pipeline allows.

9. The network device of claim 8, in which the control plane further includes a policer module configured to receive replicated multicast packet on the main control plane pipeline from the multicast processing engine, the main control plane pipeline containing at least one of unicast, layer 2 (L2), and multi-protocol label switching (MPLS) traffic.

10. A control plane multicast packet processing engine, comprising:
a circular replication buffer for facilitating multithreaded replication of multicast packets on a per egress virtual local area network (VLAN) replication basis; and
a scheduler in communication with a shared transmit/receive queue infrastructure for queuing incoming multicast packets to be replicated on a per ingress port basis and for queuing transmit packets, the schedule being configured to de-queue multicast packets associated with the ingress ports into the circular replication buffer, the scheduler utilizing scheduling algorithms to dynamically adapt the rate at which the multicast packets are de-queued from each ingress port as a function of how much output bandwidth each ingress port utilizes.

11. The control plane multicast packet processing engine of claim 10, in which the scheduler is configured to request multicast packets from the shared transmit/receive queue infrastructure upon a slot emptying in the circular replication buffer, the requested multicast packet being from an ingress port determined based on a bandwidth management policy implemented by the scheduler, and in which the slot in the circular replication buffer is emptied when all replications for the multicast packet occupying the slot are performed.

12. The control plane multicast packet processing engine of claim 10, in which the scheduler is configured to request multicast packets from the shared transmit/receive queue infrastructure with a policy to maintain a plurality of threads of replication in the circular replication buffer.

13. The control plane multicast packet processing engine of claim 10, in which the multicast processing engine forwards a replicated multicast packet onto a main control plane pipeline when traffic on the main control plane pipeline allows.

14. The control plane multicast packet processing engine of claim 13, in which the main control plane pipeline contains at least one of unicast, layer 2 (L2), and multi-protocol label switching (MPLS) traffic.

15. A computer program package embodied on a computer readable medium, the computer program package including instructions that, when executed by a processor, cause the processor to perform actions comprising:
queuing incoming multicast packets to be replicated on a per ingress port basis in a shared transmit/receive queue infrastructure, the shared transmit/receive queue infrastructure being configured to queue the incoming multicast packets to be replicated and transmit packets;
determining an ingress port from which to de-queue multicast packets;
de-queuing multicast packets from the shared transmit/receive queue infrastructure, the de-queued multicast packets being associated with the determined ingress port and placed into a replication buffer for replication; and
performing multithreaded replication of multicast packets on a per egress virtual local area network (VLAN) replication basis utilizing a replication buffer

16. The computer program package of claim 15, in which the de-queuing is performed upon a slot in the replication buffer being emptied and in which the slot in the replication buffer is emptied when all replications for the multicast packet occupying the slot are performed.

17. The computer program package of claim 15, in which the determining the ingress port from which to de-queue multicast packets is based on a bandwidth management policy.

18. The computer program package of claim 15, in which the de-queuing of the multicast packets from the shared transmit/receive queue infrastructure for each ingress port is at a rate dynamically adapted as a function of how much output bandwidth each ingress port utilizes.

19. The computer program package of claim 15, in which the de-queuing of the multicast packets from the shared transmit/receive queue infrastructure is implemented with a policy to maintain a plurality of threads of replication in the circular replication buffer.

20. The computer program package of claim 15 including instructions that cause the processor to perform actions further comprising:
forwarding replicated multicast packet onto a main control plane pipeline when traffic on the main control plane pipeline allows.
